(19) United States
(12) Patent Application Publication
(10) Pub. No.: US 2021/0331663 A1
(43) Pub. Date: Oct. 28, 2021

(54) ELECTRIC VEHICLE CONTROL SYSTEM

(71) Applicant: Potential Motors Inc., Hanwell (CA)

(72) Inventors: Christopher NEWTON, Fredericton (CA); Marcel LEBRUN, Fredericton (CA); Samuel POIRIER, Fredericton (CA); Isaac BARKHOUSE, Fredericton (CA); Nicholas DOWLING, Fredericton (CA)

(21) Appl. No.: 17/240,980

(22) Filed: Apr. 26, 2021

Related U.S. Application Data
(60) Provisional application No. 63/015,602, filed on Apr. 26, 2020.

(51) Int. Cl. B60W 30/02; B60W 40/08; B60W 10/08; B60W 10/20; B60W 10/22; B60W 40/06

(52) U.S. Cl. CPC B60W 30/02; G06N 20/00; B60W 10/08; B60W 10/20; B60W 10/22; B60W 40/06; B60W 2540/10; B60W 2540/18; B60W 2520/16; B60W 2520/14; B60W 2520/18; B60W 2520/105; B60W 2420/50; B60W 2555/20; B60W 2552/00; B60W 40/08

(57) ABSTRACT

Method and system that includes receiving data about (1) a driver's expected vehicle performance and (2) a difference between the driver's expected vehicle performance and an estimated actual vehicle performance, and based on the received data determining control signals for an electric drivetrain system to effect the driver's expected vehicle performance. A vehicle control system that incorporates one or machine learning functions to control a drivetrain that is decoupled from a driver.

### RELATED APPLICATIONS

This application claims priority to and benefit of U.S. Provisional Patent Application No. 63/015,602, filed Apr. 26, 2020, titled “ELECTRIC VEHICLE CONTROL SYSTEM”, the contents of which are incorporated herein by reference.

### TECHNICAL FIELD

The present disclosure relates to electric vehicles and more particularly to a control system for an electric vehicle.

### BACKGROUND

In a traditional automobile, driver controls such as steering wheel, throttle and brake, are mechanically coupled to the wheels of the vehicle such that each action that driver makes results in a proportional response at the wheels. As vehicles transition to be built upon electric platforms that are increasingly software controlled there will be a move to decouple the driver from directly controlling the wheels of the vehicle. Steer, throttle, and brake by wire systems will become more standard, however currently when these are implemented they are still done in a way that mimics a mechanical coupling between the driver and the independent controls (steering, braking, and accelerating of the wheels).

Advanced driver assistance systems (ADAS) are becoming common and can improve vehicle safety, driver experience and overall vehicle performance. However, ADAS systems are typically reactive based.

There is a need for a proactive electric vehicle (EV) control system that can control the vehicle to function as intended by a driver.

### SUMMARY

According to a first example aspect is a method that includes receiving data about (1) a driver's expected vehicle performance and (2) a difference between the driver's expected vehicle performance and an estimated actual vehicle performance, and based on the received data determining control signals. The control signals may be configured to implement the driver's expected vehicle performance.

According to a second example aspect is a predictive conditioning unit comprising a processor coupled to an I/O interface and a non-volatile memory, the memory storing instructions that when executed by the processor configure the predictive conditioning unit to receive data through the I/O interface about (1) a driver's expected vehicle performance and (2) a difference between the driver's expected vehicle performance and an estimated actual vehicle performance, and based on the received data generate control signals for an electric drivetrain system. The control signals may be configured to implement the driver's expected vehicle performance.

According to further aspects is a vehicle control system that incorporates the predictive conditioning unit.

According to further aspects is a vehicle control system that incorporates one or more machine learning functions to control a drivetrain that is decoupled from a driver.

According to a further example aspect is a computer implemented method for assisting a human driver to control operation of a vehicle, comprising: receiving, through one or more human-vehicle control interfaces, real time driver controls input data indicating a throttle input signal and a steering angle input signal; receiving, through one or more vehicle embedded sensor systems, real-time positional state data about the vehicle; computing, based on the throttle input signal, steering angle input signal, and real-time positional state data a driver's expected vehicle performance; computing, based on the real-time positional state data, an actual vehicle performance; computing, based on the driver's expected vehicle performance and a difference between the driver's expected vehicle performance and the actual vehicle performance, control signals for an electric drivetrain system of the vehicle; and applying the control signals to the electric drivetrain system to control real-time operation of the vehicle.

According to a further example aspect is a vehicle control system for assisting a human driver to control operation of a vehicle, the vehicle control system comprising one or more processors and one or more memories storing software instructions that, when executed by the one or more processors, configure the vehicle control system to perform the methods of any of the preceding aspects.

According to a further example aspect is a computer readable medium that stores software instructions that configure one or more processors of a vehicle control system to perform the methods of any of the preceding aspects.

### BRIEF DESCRIPTION OF THE DRAWINGS

FIG. 1 is a schematic diagram of a vehicle that includes a vehicle control system in accordance with example embodiments of the present disclosure.

FIG. 2 is a block diagram of an electric drivetrain system of the vehicle of FIG. 1.

FIG. 3 is a block diagram showing a vehicle control system and selected cooperating components in accordance with example embodiments of the present disclosure.

FIG. 4 is a block diagram of a predictive conditioner of the vehicle control system of FIG. 3.

FIG. 5 is a block diagram of a processor system according to example embodiments.

### DESCRIPTION OF EXAMPLE EMBODIMENTS

For convenience, the present disclosure describes example embodiments of methods and systems with reference to a motor driven vehicle, such as a car, truck, bus, self-powered trailer, recreational vehicle, military vehicle, warehouse vehicle, construction vehicle, tractor or other farm equipment. The teachings of the present disclosure are not limited to any particular type of powered vehicle and aspects described in this disclosure can be adapted to apply to many types of vehicle platforms.

Example embodiments are directed to a vehicle control system that is configured to interpret a driver's intended path (also referred to herein as expected path) based on driver inputs as well as on an accurate understanding of the vehicle's past, present, and future position in the surrounding environment. This understanding of the environment is estimated based on an array of vehicle embedded sensors that retrieve data from the environment. The disclosed vehicle control system makes control decisions based on an awareness of the vehicle's surrounding environment and a driver's control inputs. In at least some applications, such a system may be capable of acting out the driver's expectations in a way that increases performance of the vehicle while reducing the likelihood of an accident. In example embodiments, the driver's control inputs are decoupled from the vehicles drivetrain system and subjected to intermediate conditioning by the vehicle control system that determines how to effectively execute the intended purpose of the driver's control inputs in view of the vehicle's actual environment. In at least some applications, the use of a vehicle control system that decouples actuators of the vehicle drivetrain system from the driver may enable the vehicle actuators to act at significantly higher speeds than that of a human reaction time allowing for actions to be taken for on-coming hazards before the driver even realizes there is an issue.

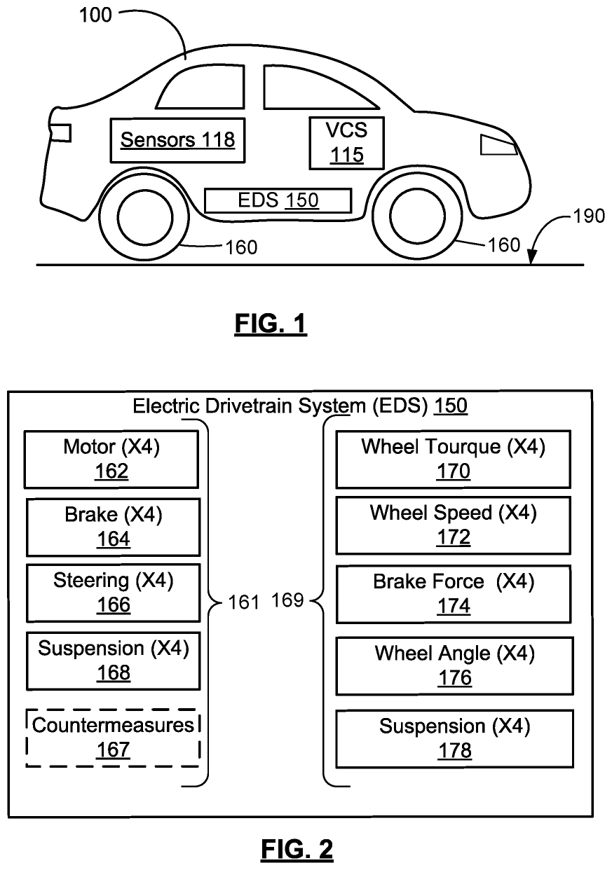

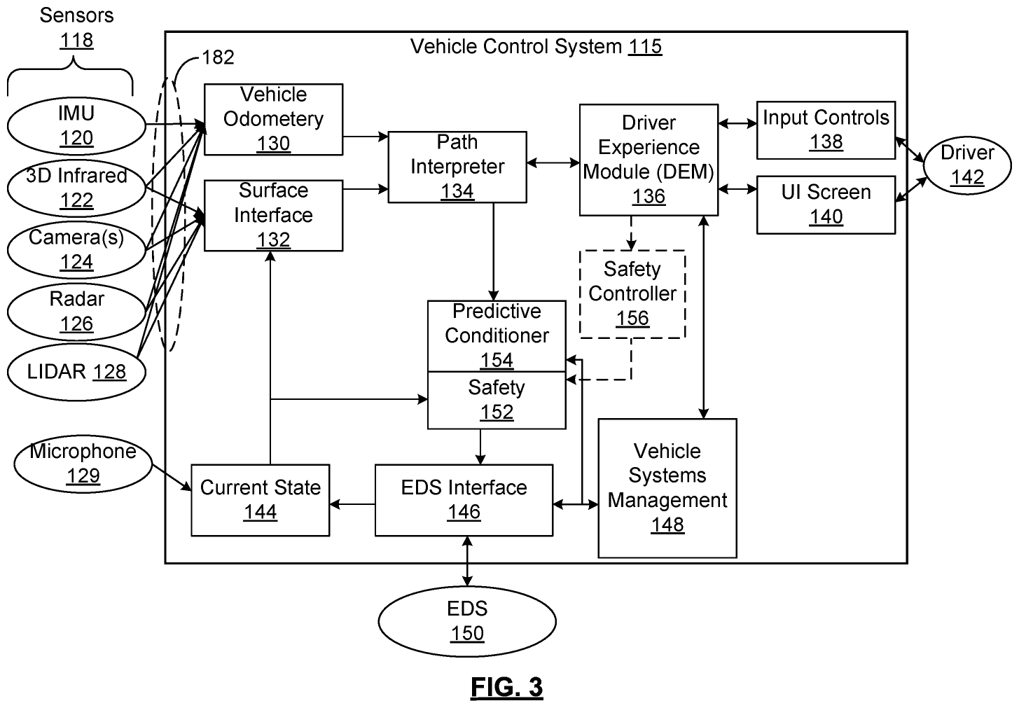

In this regard, FIG. 1 is a schematic diagram showing an example of a vehicle 100 that incorporates an on-board vehicle control system (VCS) 115 according to example embodiments. In the illustrated embodiment, vehicle 100 includes four wheels 160 that engage a road surface 190, although in some applications the methods and systems described herein can be adopted for vehicles having more than or less than 4 wheels, or other type of surface interface such as drive tracks. VCS system 115, shown in greater detail in FIG. 3, is coupled to receive information about the vehicle 100 and its surrounding environment from a plurality of vehicle embedded sensors 118. VCS system 115 is also coupled to provide control signals to and receive information from an electric drivetrain system (EDS) 150 of the vehicle 100. As indicated in FIG. 2, EDS 150 includes a plurality of controllable components 161 (e.g., actuators) that control the operation of the wheels 160 of the vehicle 100, including among other things, drive torque, breaking torque and steering angle.

In the illustrated embodiment, the controllable components 161 of electric drivetrain system 150 can include, among other things, the following:

(1) Electric motors 162: In the illustrated embodiment, EDS 150 includes an independently controlled variable torque electric drive motor 162 for each wheel 160 of vehicle 100. The direction (e.g. forward, reverse) and magnitude of the throttle torque applied by each of the four motors 162 is controlled by a respective throttle control signal from VCS 115. In some alternative examples, EDS 150 may include motors that apply torque to multiple wheels.

(2) Brake systems 164: EDS 150 includes an independently controlled variable braking system 164 for each wheel 160 of vehicle 100. The magnitude of the braking torque applied by each brake system 164 is controlled by a respective brake control signal from VCS 115.

(3) Steering actuators 166: EDS 150 includes an independently controlled steering actuator 166 for each wheel 160 of vehicle 100. The steering angle applied by each steering actuator 166 is controlled by a respective steering angle control signal from VCS 115.

(4) Suspension system 168: In at least some example embodiments, EDS includes an independently controlled suspension system 168 (e.g., shock absorber and spring system) for each wheel 160 of vehicle 100. Different attributes of each suspension system 168 can be controlled by respective control signals from the VCS 115, for example: damper rebound, damper compression, ride height, and spring rate.

EDS 150 could also include other controllable components 161 including for example controllable countermeasure systems 167 such as tire system controllers that may control tire pressure via an automated tire inflation/deflation system and/or may control features such as deployable traction studs. Other controllable components 161 that are not shown may include a battery management system (BMS), a battery charger system, and an EDS temperature control system for temperature management of EDS components.

EDS 150 includes a set of drivetrain sensors 169 for measuring information about the real time state of the drivetrain components and generating corresponding sensor signals indicating the measured attributes as feedback to VCS 115. In the illustrated embodiment, the drivetrain sensors 169 can include, among other things, the following sensors for each of the four wheels 160: (1) Wheel torque sensor 170 for sensing torque applied to wheel 160 by motor 162. (2) Wheel speed sensor 172 for sensing actual rotational speed of the wheel 160. (3) Brake pressure sensor 174 for sensing actual braking force applied to the wheel 160. (4) Wheel angle sensor 176 for sensing the actual angle of the wheel 160. (5) Suspension system sensors 178 for measuring suspension system related attributes for the wheel 160. Suspension system sensors 178 may for example measure: wheel loading (e.g., weight of vehicle on the wheel), and suspension compression/extension.

EDS drivetrain sensors 169 can also include other system sensors that generate respective sensor signals, including for example brake temperature, tire pressure, motor temperature sensors and battery temperature and charge state sensors. EDS 150 can also include sensors that detect error conditions in EDS components and send corresponding error messages.

Referring to FIG. 3, vehicle embedded sensors 118 are coupled to VCS 115 and are configured to sense information about the real time environment of the vehicle 100. In this regard, vehicle embedded sensors 118 can include, among other things: (1) Inertial measurement unit (IMU) 120; (2) 3D Infrared camera system 122; (3) Video camera system 124; (4) Radar system 126 (e.g., one or more synthetic aperture radar (SAR) units); (5) light detection and ranging (LIDAR) system 124; and (6) Acoustic transducer (e.g., microphone) system 129. It will be noted that sensors (2) 3D Infrared camera system 122; (3) Video camera system 124; (4) Radar system 126 (e.g., one or more synthetic aperture radar (SAR) units); and (5) light detection and ranging (LIDAR) system 124 each function based on detected electromagnetic (EM) wave energy.

In example embodiments, IMU 120 includes one or more accelerometers and directional sensors to measure the following real-time attributes about the pose and movement of vehicle 100: yaw position, pitch position, roll position, lateral velocity, longitudinal velocity, vertical velocity, lateral acceleration, longitudinal acceleration and vertical acceleration. Collectively, IMU 120 may generate respective signals representing each of these attributes.

3D Infrared camera system 122, Video camera system 124, Radar system 126 and LIDAR system 124 may each include one or more sensing units located about the vehicle 100. In an example embodiment, digital cameras of Video camera system 124, LIDAR units of LIDAR system 124, and SAR units of the Radar system 126 are located at the front, rear, left side and right side of the vehicle 100. The digital cameras, LIDAR units and radar units are mounted or otherwise located to have different fields of view (FOVs) or coverage areas to capture information about the environment surrounding the vehicle 100. In some examples, the FOVs or coverage areas of some or all of the adjacent embedded sensors 118 are partially overlapping. In at least some examples, the coverage areas are divided into zones, including for example a front zone, a back zone, and right and left side zones. Accordingly, the VCS 115 receives information about the external environment of the vehicle 100 as collected by 3D Infrared camera system 122, video camera system 124, Radar system 126 and LIDAR system 124. In at least some examples, one or more of 3D Infrared camera system 122, Video camera system 124, Radar system 126 and LIDAR system 124 are configured with on-board processing and can perform pre-processing of collected information before providing the collected information to other systems of the VCS 115 as feature map and/or point cloud data (collectively embedded sensor data 182).

In example embodiments, 3D Infrared camera system 122 includes one or more infrared cameras that capture 3D thermal images that are representative of the thermal environment surrounding the vehicle 100. By way of example, 3D Infrared camera system 122 can include a forward facing (e.g. front zone) infrared camera system that captures road surface images in the forward direction of travel. The thermal information contained in such images may indicate upcoming road surface features such as pooled water, black ice, accumulated snow, change in road surface material, among other things. In example embodiments, 3D Infrared camera system 122 generates one or more thermal image maps that are included in embedded sensor data 182.

As indicated in FIG. 3, VCS 115 comprises a plurality of computational units. In the illustrated example, the computational units, which will each be explained in greater detail below, include: vehicle odometry unit 130, surface interface unit 132, path interpreter unit 134, driver experience module (DEM) 136, driver input control unit 138, user interface (UI) display screen unit 140, safety unit 152, predictive conditioner unit 154, current state unit 144, EDS interface unit 146 and vehicle systems management unit 148. In example embodiments, these units are implemented by one more vehicle onboard processor systems 215 (described in greater detail below) that are hardware and software configured to perform the operations described below. In some examples, multiple computational units may be implemented using the same processor system 215, and in some applications the computational units may be distributed across multiple processor systems 215.

The computational units of VCS 115 will now be described in greater detail.

As indicated in FIG. 3, in example embodiments, VCS 115 interfaces with a human driver 142 of vehicle 100 through a driver input controls unit 138 and a UI display screen unit 140. The driver input controls unit 138 normalizes and filters control data that is received directly from hardware systems that the driver is interfacing with, including driver-vehicle control interfaces such as a steering wheel, accelerator pedal and brake pedal, as well as buttons and controls that the driver can interact with outside of those that exist within the UI screen unit 140. In example embodiments, driver input control system 138 is coupled to: an accelerator pedal and generates a corresponding variable throttle input signal (Ti); a brake pedal and generates a corresponding variable brake input signal (Bi); a steering wheel and generates a corresponding steering angle input signal (Sai); and a directional control (e.g., forward/reverse control) that and generates a corresponding vehicle direction input signal (Di). In some examples, directional input signal may be combined with the throttle input signal Ti, such that a negative signal indicates a reverse direction and a positive signal indicates a forward direction. In some examples, the throttle input signal Ti, variable brake input signal Bi, and vehicle direction input signal Di may all be mapped to a torque input signal (Tqi). The driver input control unit 138 generates real time driver controls input data (e.g., throttle data, steering angle data, brake data, directional data, and/or torque data) based on the signals it receives from driver interfaces, and provides the driver controls input data to DEM unit 136. The driver controls input data is indicative of the driver's intensions.

In example embodiments UI display screen unit 140 includes a touchscreen that is the driver's point of contact for modifying the overall parameters of driving that the driver would like to experience. By way of example, UI display screen 140 may enable a driver to modify parameters for an expected driver experience, such as parameters regarding suspension system performance and acceleration rates, among other things. UI display screen unit 140 also controls the infotainment portion of the vehicle, having several layers to allow for control over entertainment, climate control, vehicle settings, and peripheral controls for the vehicle.

DEM unit 136 functions as an interface between the VCS driver interfaces (e.g., input controls unit 138 and UI display screen unit 140) and the other computational units of VCS 115. DEM unit 136 receives driver controls input data from the driver input control unit 138, and provides that data to path interpreter 134 on a real-time basis. DEM unit 136 may also select a driver experience mode for the vehicle 100 (e.g., sport mode; off-road mode; comfort mode) based on the driver's input of driving parameters through the UI display screen unit 140. DEM unit 136 provides updates regarding changes to the selected driver experience mode to path interpreter 134.

DEM unit 136 can also provide feedback signals to input control unit 138 that then outputs corresponding control signals that control tactile feedback provided to the driver through the driver interface elements such as a steering wheel, accelerator pedal and brake pedal. DEM unit 136 is also configured to receive selected vehicle state data such as velocity, acceleration, and traction information from other VCS unit(s) (e.g. from path interpreter 134) and provide that information as driver feedback using UI display screen unit 140. DEM unit 136 provides a layer of decoupling between the driver input controls and the EDS 150.

EDS interface unit 146 is configured to act as the interface between the computational units of VCS 115 and the controllable components 161 (e.g., actuators) and drivetrain sensors 169 that make up EDS 150. Among other things EDS interface 146 converts signals incoming from the EDS 150 into a format suitable for the communication protocols implemented within the VCS 115, and converts signals outgoing from the VCS 115 into a format suitable for the signaling protocols of the components of the EDS 150. In example embodiments, EDS interface unit 146 receives normalized control signals from the safety unit 152 that indicate the following in respect of each of the four independently actuated wheels 160: (1) Throttle torque control (TTc) signal that specifies direction (e.g. forward, reverse) and magnitude of the throttle torque to be applied by each motor 162. (2) Brake torque control (BTc) signal that specifies magnitude of the braking torque applied by each brake system 164. (3) Steering angle control (SAc) signal that specifies a steering angle applied by each steering actuator 166. (4) Suspension system control signals (SCc) signals that controls the suspension system 168 for each wheel 160 of vehicle 100. Different attributes of each suspension system 168 can be controlled by respective control signals, for example: damper rebound (DRc), damper compression (DCc), ride height (RHc), and spring rate (SRc). The signals are collectively referred to as “EDS control signals”. In some examples, throttle torque control TTc signal and brake torque control BTc signal for each wheel may be incorporated into a wheel torque control (WTc) signal.

EDS interface unit 146 is configured to convert the normalized control signals received from safety unit 152 to respective input formats suitable for the controllable components 161 that make up EDS 150.

EDS interface unit 146 also receives sensor signals and error messages from the drivetrain sensors 169 of EDS 150 and converts the raw sensor signals into normalized values that provide current vehicle operating state information in a format suitable for various computational units of the VCS 115. For example, the vehicle operating state information could include: (1) Wheel torque data (WTd) derived from each wheel torque sensor 170 indicating torque applied to wheel 160 by motor 162. (2) Wheel speed data (WSd) derived from each wheel speed sensor 172, indicating actual rotational speed of the wheel 160. (3) Brake pressure data (BPd) derived from each brake pressure sensor 174, indicating actual braking force applied to the wheel 160. (4) Wheel angle data (WAd) derived from each wheel angle sensor 176, indicating the actual angle of the wheel 160. (5) Suspension system data derived from suspension system sensors 178, indicating suspension system related attributes for the wheel 160. Suspension system data may for example indicate wheel loading (WLd) and suspension compression/extension (SDd). EDS interface unit 146 may also receive other sensed vehicle state information from other sensors 169 of the EDS system 150 such as tire pressure for each wheel 160, motor temperature, and battery state (e.g., remaining charge, remaining power and temperature), as well as component error messages. The real-time data received from the EDS system 150 collectively constitutes vehicle EDS state data.

Current state unit 144 is configured to receive and manage vehicle EDS state data from the EDS interface. Current state unit 144 can provide the vehicle EDS state data to other units of the VCS 115 for processing as described below.

In example embodiments, vehicle systems management unit 148 is configured to manage one or more underlying systems within a vehicle such as the battery management system (BMS), vehicle charging, as well as errors that need to be sent to the driver or other systems within the vehicle. In this regard, vehicle systems management unit 148 may receive, as inputs, from EDS interface and/or current state unit 144, state data indicating current battery state, motor temperature, and EDS system error messages. Based on the inputs it receives, vehicle systems management unit 148 may send control signals to the EDS interface 146 for one or more of the BMS, EDS temperature control system and charger control systems. Vehicle systems management unit 148 may also provide vehicle state data such as error conditions and temperature data to DEM unit 136 to provide feedback to the driver through UI display screen unit 140.

Vehicle odometry unit 130 is configured to determine a current pose and movement state of the vehicle 100 in space. In this regard, vehicle odometry unit 130 receives sensor data 182 from a plurality of the embedded sensor systems 118 and uses that data to estimate current vehicle odometry. This includes the velocity and acceleration of the vehicle 105, and roll, pitch, and yaw positions (collectively, “pose”) as well as rates of positional change of the vehicle in 3-dimentions (laterally(y), longitudinally(x) and vertically (z)). In example embodiments, vehicle odometry unit 130 successively outputs the following real-time set of odometry attributes: current yaw position, current pitch position, current roll position, roll rate, pitch rate, roll rate, lateral velocity, longitudinal velocity, vertical velocity, lateral acceleration, longitudinal acceleration and vertical acceleration. In some examples, vehicle odometry unit 130 is configured to process data received from the IMU 120 in combination with image and point cloud data from other embedded sensors such as 3D Infrared camera system 122, video camera system 124, radar system 126 and LIDAR system 124. In example embodiments the image and point cloud data is used to refine the information received from IMU 120 to provide hyper-location data about the position and movement of the vehicle 100. The vehicle position and movement state data generated by vehicle odometry system 130 is provided to path interpreter unit 134. Surface interface unit 132 is configured to estimate the surface condition of current and upcoming road surface 190 based on: (1) sensor data 182 (e.g., image and point cloud sensor data from sensors such as one or more of 3D Infrared camera system 122, video camera system 124, radar system 126 and LIDAR system 124); and (2) current vehicle drive system operating state data (e.g., vehicle EDS state data) received from current state unit 144. In example embodiments, surface interface unit 132 is configured to estimate current and upcoming road surface conditions and output road surface data indicating one or more of: surface terrain roughness (e.g., presence of potholes or other uneven features in the surface of road 190); road; terrain type (e.g., snow, ice, water pooling, dirt surface, paved surface) and estimated road friction at each wheel/road interface. In at least some examples, the estimated road surface conditions (collectively “current road surface state”) generated by surface interface unit 132 are indicative of the amount of grip that will be available to the vehicle 100 and upcoming road surface hazards, such as but not limited to potholes, variation in surface friction, and changes in road elevation. The current road surface state data generated by surface interface unit 132 is provided to path interpreter 134.

Path interpreter unit 134 is configured to receive as inputs: vehicle position and movement state data from vehicle odometry unit 130; road surface state data from surface interface unit 132; and driver controls input data and selected driver experience mode from DEM unit 136. Path interpreter unit 134 is configured to process these inputs to: estimate a driver's expected path, acceleration and velocity; estimate a driver's expected roll, pitch and yaw position and rate; determine the difference (delta) between the estimated driver's expected path, acceleration and velocity and the actual vehicle path, acceleration and velocity; determine the difference (delta) between the estimated driver's expected roll, pitch and yaw position and rate and the actual vehicle roll, pitch and yaw position and rate.

Thus, the path interpreter unit 134 generates a driver's expected vehicle performance (e.g., expected path, expected vehicle pose and pose rate (e.g., roll, pitch, yaw and roll, pitch, yaw rates), expected velocity and acceleration in orthogonal x,y,z axis reference frame) based on: (1) driver inputs received from DEM module 136; and (2) vehicle pose and movement state data from vehicle odometry unit 130. In some examples, the expected vehicle performance may also be based on road surface state data from surface interface unit 132. In some examples, path interpreter unit 134 may include a trained ML model that maps the above inputs to an expected vehicle performance.

The path interpreter unit 134 also generates an estimation of actual current vehicle performance (e.g., vehicle pose and pose rate, velocity and acceleration in orthogonal x,y,z axis reference frame) based on (1) vehicle pose and movement state data from vehicle odometry unit 130; and (2) road surface state data from surface interface unit 132. In some examples, path interpreter unit 134 may include a trained ML model that maps the inputs from vehicle odometry unit 130 and surface interface unit 132 to an actual current vehicle performance.

The path interpreter unit 134 is configured to compare the driver's expected vehicle performance with the estimated actual vehicle performance and generate performance delta data that indicates the differences between the driver's expected vehicle performance and the estimated actual vehicle performance. For example the performance delta data may include: (1) difference between: driver expected roll, pitch, yaw and vehicle's current roll, pitch, yaw; (2) difference between: driver expected roll, pitch, yaw rates and vehicle's current roll, pitch, yaw rates; (3) difference between driver expected X, Y and Z velocities and vehicle's current X, Y and Z velocities; and (4) difference between driver expected X, Y and Z accelerations and vehicle's current X, Y and Z accelerations. In example embodiments, the path interpreter unit 134 is also configured to generate, based on vehicle pose and movement state data from vehicle odometry unit 130; and road surface state data from surface interface unit 132: (1) an estimation of the grip available between each of the wheels 160 and the road surface 190 (“available grip data”); (2) a short term terrain feature map for all four wheels 160 representing the next “X” (e.g., 50 milliseconds) of 3d terrain data (e.g., changes in elevation for the next X milliseconds in the direction of travel across a width of the wheel/surface interface), per wheel to allow suspension control operations; (3) road surface data indicating features of road surface water such type and quantity (e.g. snow[deep], wet[slight], wet[standingwater], ice [black]).

In example embodiments, the path interpreter unit 134 is also configured to output component failure information based in data received through vehicle system management unit 148 either directly or via DEM unit 136.

Data generated by path interpreter unit 134, namely (1) driver's expected vehicle performance, (2) performance delta data, (3) available grip data, (4) short term terrain feature map (per wheel), (5) road surface data, and (6) component failure information (collectively referred to as “path data”) are all provided as inputs to predictive conditioner unit 154.

Predictive conditioner unit 154 is configured to determine, based on the path data it receives from the path interpreter unit 134, what EDS control signals should be provided through the EDS interface 146 to the EDS 150. In particular, predictive conditioner unit 154 predicts, based on the path data, the EDS control signal that should be provided to the controllable components 161 in order to implement the driver's expected vehicle performance. In effect, the predictive conditioner unit 154 generates control signals that are versions of the driver's original control inputs that have been intelligently conditioned to achieve the driver's expected vehicle performance.

As noted above, the EDS control signals can include: (1) Throttle torque control (TTc) signal that specifies direction (e.g. forward, reverse) and magnitude of the throttle torque to be applied by each motor 162. (2) Brake control signal (BTc) that specifies magnitude of the braking torque applied by each brake system 164 is controlled by a respective. (3) Steering angle control signal (SAc) that specifies a steering angle applied by each steering actuator 166. (4) Suspension system control signals (SCc) that control the suspension system 168 for each wheel 160 of vehicle 100. Different attributes of each suspension system 168 can be controlled by respective control signals, for example: damper rebound (DRc), damper compression (DCc), ride height (RHc), and spring rate (SRc).

In at least some examples, the component failure data can be applied by the predictive conditioner unit 154 in manner that allows it to compensate for failure of some of controllable components 161. For example, a suspension system failure, motor failure, or other failure in respect of one of the wheel systems can be compensated by modifying the EDS control signals to both the affected and unaffected controllable components 161, thereby mitigating against impact of the failed component on the driver's expected vehicle performance.

In example embodiments, the safety unit 152 is configured to perform a final confirmation that the EDS control signals issued by the predictive conditioner unit 154 can be safely performed. In this regard, safety unit 152, in some examples, also receives as an input the vehicle EDS state data. Safety unit 152 predicts the outcome on the vehicle state that will result from application of the EDS control signals, and will abort or alter EDS control signal that are predicted to result in an unsafe vehicle state. In this regard, safety unit 152 may be configured to determine if respective attributes of the predicted vehicle state fall within respective “safe” threshold ranges or not. If the safety thresholds are met, the safety unit 152 passes the EDS control signals generated by the predictive conditioner 154 to the EDS interface 146 to be implemented by the EDS 150.

In an example embodiment, VCS system 115 includes a safety controller unit 156 that receives a wheel torque control (WTc) signal and steering angle control (SAc) signal based on driver control inputs either directly from the input controls 138 or through the DEM 136. The safety controller unit 156 may for example apply a simple Ackermann steering model with simple torque mapping to perform an Automotive Safety integrity Level (ASIL) D analysis and generate safe wheel torque control and steering angle control parameters that are passed onto the safety unit 152. Safety unit 152 can be configured to confirm that the EDS control signals fall within the safe wheel torque control and steering angle control parameters, and to perform corrective adjustments to the EDS control signals to bring such signals into conformance with the safe wheel torque control and steering angle control parameters if required.

In example embodiments, some of the various computational units of VCS 115 can be implemented using deterministic rules based models, some can be implemented using machine learning (ML) models, and some can be implemented using a combination of rules-based and ML models.

In at least some example embodiments the computational units that incorporate an ML model can be trained though simulated reinforcement learning, actual reinforcement learning, simulated supervised training, actual supervised training, and combinations thereof.

In at least some examples, surface interface unit 132, path interpreter unit 134 and predictive conditioner unit 154 each incorporate a ML model.

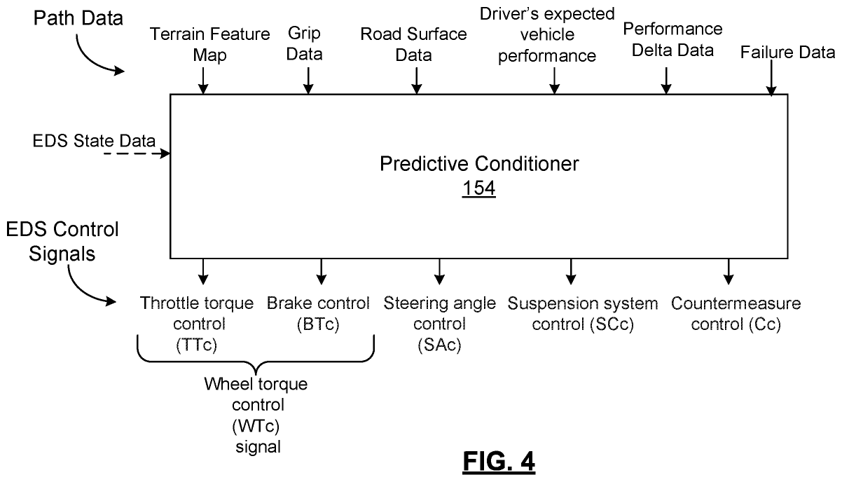

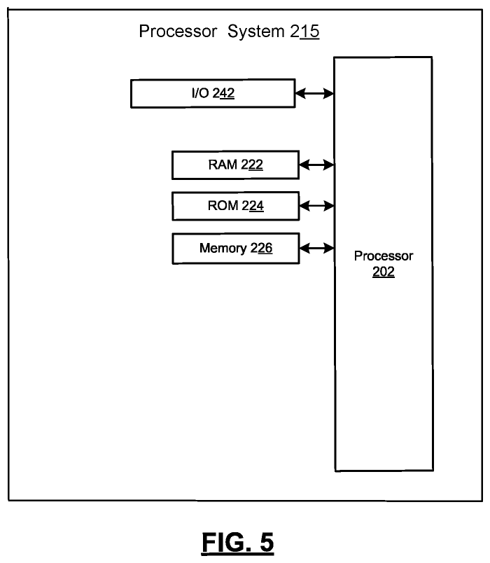

In this regard, FIG. 4 illustrates predictive conditioner 154 with its respective input and output variables. As described above, predictive conditioner 154 performs a prediction task of mapping path data from the path interpreter 134 to a plurality of EDS control signals with the objective of generating EDS control signals that achieve the driver's expected vehicle performance. In this regard, the path data that is input to predictive conditioner 154 can be summarized in the following Table 1:

TABLE 1
Path Data

| PATH DATA CATEGORY | DESCRIPTION |
|---|---|
| Terrain Feature Map | Short term terrain feature map for all |
| | four wheels 160 representing the next |
| | “X” (e.g., 50) milliseconds of 3D terrain |
| | data (e.g., represents expected |
| | upcoming changes in elevation of |
| | terrain) |
| Grip Data | Estimation of the grip available |
| | between each of the wheels 160 and |
| | the road surface 190 |
| Road Surface Data | data indicating surface covering such |
| | type and quantity (e.g. snow[deep], |
| | wet[slight], wet[standingwater]). |
| Driver's expected | expected path, expected vehicle pose, |
| vehicle performance | expected velocity and acceleration in |
| | orthogonal x, y, z axis reference frame |
| Performance Delta Data | difference between driver's expected |
| | vehicle performance and vehicle's |
| | current performance |
| Failure Data | EDS component failure information |
| | (e.g., suspension system failure, motor |
| | failure, brake failure, tire failure, etc.) |

Although EDS state data can be embedded in the data that is generated by surface interface 132, in some example embodiments, the predictive conditioner 154 may also receive some or all of EDS state data as direct inputs from current state unit 144.

The EDS control signals that are generated by the predictive conditioner 154 can be summarized in the following Table 2:

TABLE 2
EDS Control Signals

| SIGNAL CATEGORY | DESCRIPTION |
|---|---|
| Wheel torque control (WTc) | Signal that specifies direction (e.g. |
| | forward, reverse) and magnitude of the |
| | torque to be applied by each |
| | motor/brake system to its respective |
| | wheel (may include separate throttle |
| | torque control (TTc) signal and brake |
| | torque control (BTc) signal) |
| Steering angle control (SAc) | signal that specifies a steering angle |
| | applied by each steering actuator |
| Suspension system control | signals that controls the suspension |
| signals (SCc) | system 168 for each wheel 160 of |
| | vehicle 100. Different attributes of |
| | each suspension system 168 can be |
| | controlled by respective control signals, |
| | for example: damper rebound (DRc), |
| | damper compression (DCc), ride height |
| | (RHc), and spring rate (SRc). |
| Countermeasure control (Cc) | Signals that control countermeasure |
| | systems (e.g., tire stud deployment; |
| | tire pressure adjustment.) |

In example embodiments, predictive conditioner 154 incorporates a deep neural network (DNN) model that applies a predefined set of network parameters (e.g., weights and biases) to perform the above prediction task during real-time operation of vehicle 100. The network parameters are learned during a training process using a series of training procedures that begin with using an “ideal” simulated vehicle (an “advisor”) as a reference. The advisor simulates a vehicle driving in optimal conditions (e.g., good grip on a vehicle road surface interfaces, plane terrain, no external perturbations). The predictive conditioner 154 is trained to control a simulated vehicle (“agent vehicle”) to mimic the advisor's behavior in a realistically simulated, high-fidelity environment, which includes varying friction values, slopes and banks on the road, potholes, and other external forces (e.g. lateral forces caused by wind blasts).

Training commences using multiple sets of initial defined conditions for multiple training episodes. Each training episode is short (for example, 10-20 secs), so to generalize the predictive conditioner's learning. Using multiple sets of initial defined conditions allows the predictive conditioner to learn from multiple episodes having varied starting conditions. These conditions include, but are not limited to: velocity & acceleration; wheel rotation & rate of change of rotation; surface friction; driver inputs.

In some examples, the reward function that is applied during training is based on a weighted average of a Radial-Basis-Functions (RBF) comparison of the current state of the agent vehicle controlled by the predictive conditioner 154 relative to the current state of the advisor. A set of vehicle states coming from both the agent vehicle and the advisor are compared to determine how efficiently the predictive conditioner is controlling the agent vehicle. Instead of using a simple error, RBF is applied to the error in order to constrain the maximum and minimum reward to a value in range [0, 1].

The parameters used for comparison include, but are not limited to: vehicle pose and vehicle pose rates (3D); velocity and velocity rates (3D); acceleration and acceleration rates (3D); rotation and rotation rates (3D); battery state of charge; and wheel revolutions per minute (×4).

Curriculum learning can be applied to train the predictive conditioner 154. As the predictive conditioner 154 progresses and converges to expected behaviour, the acceptable performance metrics can be tightened to further improve the model. Initially, predictive conditioner 154 is expected to barely match the agent vehicle's behaviour to the advisor—a higher reward is provided with poor mapping between the vehicle and the advisor. As the training continues and the predictive conditioner 154 learns to achieve maximum rewards, the accepted error between the vehicle and the advisor is reduced, such that a higher reward is provided with more accurate mapping between the agent vehicle and the advisor, enabling the predictive conditioner 154 to progressively perfect its ability to control the agent vehicle.

During training, multiple methods can be used to simulate a driver and vehicle. These methods can get progressively more complex, ending with actual driver and vehicle. In some examples, four progressive methods can be: 1. Constant input: useful for early stages and common driving behaviours. The input can either be a fixed value, a list of discrete values, or a range to randomize over. If a range is given, inputs can be randomly generated based off of a known data set distribution, including for example the A2D2 data set distribution. 2. Spline (Continuous) input: useful for maneuvering and more complex driving behaviours. This method requires a list of pairs (time step, amplitude) and a polynomial degree to generate a continuous input source. 3. Mixed input: useful for a well generalized agent, most driving behaviours. Includes a combination of constant and spline inputs and requires a probability distribution for choosing between the two (i.e. 80% constant input, 20% spline input). 4. Recorded/live input: useful for most accurate tests, validation. If recorded, requires a file (i.e., csv) of recorded user inputs; if live, requires a connection to controls (keyboard, steering wheel setup, etc.).

In example embodiments, the predictive conditioner 154 could comprise multiple parallel ML models that are each perform selected prediction tasks for subsets of one or more of the output variables generated by the predictive conditioner 154. In example embodiments, path interpreter unit 134 and surface interface unit 132 may include one or more ML models that are trained in a manner similar to predictive conditioner 154.

In illustrative example embodiments, vehicle 100 is a side-by-side recreational vehicle having 4 or more independently controllable drive wheels.

As noted above, the computational units of VCS 115 may be implemented using one or more processor systems 215. In this regard, FIG. 4 shows an example of a possible processor system 215 that may be used to implement one or more computational units of VCS 115. Processor system 215 includes processor 202 that is coupled to a plurality of components via a communication bus which provides a communication path between the components and the processor 202. The processor 202 is coupled to Random Access Memory (RAM) 222, Read Only Memory (ROM) 224, persistent (non-volatile) memory 226 such as flash erasable programmable read only memory (EPROM) (flash memory), and one or more I/O interface systems 242 for exchanging data with other systems including other processor systems 215. The processor 202 may include one or more processing units, including for example one or more central processing units (CPUs), one or more graphical processing units (GPUs), and other processing units.

The memory 226 of the processor system 215 has stored thereon data and sets of software instructions executable by the processor 202 that configure the processor system 215 to implement one or more computational units of VCS 115.

The present disclosure is made with reference to the accompanying drawings, in which embodiments are shown. However, many different embodiments may be used, and thus the description should not be construed as limited to the embodiments set forth herein. Rather, these embodiments are provided so that this disclosure will be thorough and complete. Separate boxes or illustrated separation of functional elements of illustrated systems, modules and devices does not necessarily require physical separation of such functions, as communication between such elements may occur by way of messaging, function calls, shared memory space, and so on, without any such physical separation. As such, functions need not be implemented in physically or logically separated platforms, although they are illustrated separately for ease of explanation herein. Different devices may have different designs, such that although some devices implement some functions in fixed function hardware, other devices may implement such functions in a programmable processor with code obtained from a machine readable medium.

All values and sub-ranges within disclosed ranges are also disclosed. Also, although the systems, devices and processes disclosed and shown herein may comprise a specific number of elements/components, the systems, devices and assemblies may be modified to include additional or fewer of such elements/components. For example, although any of the elements/components disclosed may be referenced as being singular, the embodiments disclosed herein may be modified to include a plurality of such elements/components. The subject matter described herein intends to cover and embrace all suitable changes in technology.

Although the present disclosure is described, at least in part, in terms of methods, a person of ordinary skill in the art will understand that the present disclosure is also directed to the various components for performing at least some of the aspects and features of the described methods, be it by way of hardware (DSPs, GPUs, ASIC, or FPGAs), software or a combination thereof. Accordingly, the technical solution of the present disclosure may be embodied in a non-volatile or non-transitory machine readable medium (e.g., optical disk, flash memory, etc.) having stored thereon executable instructions tangibly stored thereon that enable a processing device (e.g., a vehicle control system) to execute examples of the methods disclosed herein.

The present disclosure may be embodied in other specific forms without departing from the subject matter of the claims. The described example embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the embodiments set forth in the examples, but should be given the broadest interpretation consistent with the description as a whole.

1. A computer implemented method for assisting a human driver to control operation of a vehicle, comprising:
receiving, through one or more human-vehicle control interfaces, real time driver controls input data indicating a throttle input signal and a steering angle input signal;
receiving, through one or more vehicle embedded sensor systems, real-time positional state data about the vehicle;
computing, based on the throttle input signal, steering angle input signal, and real-time positional state data a driver's expected vehicle performance;
computing, based on the real-time positional state data, an actual vehicle performance;
computing, based on the driver's expected vehicle performance and a difference between the driver's expected vehicle performance and the actual vehicle performance, control signals for an electric drivetrain system of the vehicle;
applying the control signals to the electric drivetrain system to control real-time operation of the vehicle.

2. The method of claim 1 wherein the control signals include wheel torque control signals and steering angle control signals.

3. The method of claim 2 wherein the vehicle includes a suspension control system and the control signals include suspension system control signals for controlling operation of the suspension control system in real time.

4. The method of claim 2 wherein:
the actual vehicle performance computed based on the real-time positional state data is based at least on data acquired by an inertial momentum unit of the embedded sensor systems and comprises: values indicating a current vehicle pitch, yaw and roll; values indicating a current vehicle velocity in three orthogonal axis; and values indicating a current vehicle acceleration in three orthogonal axis; and
the driver's expected vehicle performance comprises: values indicating an expected vehicle pitch, yaw and roll; values indicating an expected vehicle velocity in three orthogonal axis; and values indicating an expected vehicle acceleration in three orthogonal axis.

5. The method of claim 2 wherein the one or more vehicle embedded sensor systems includes one or more electromagnetic (EM) wave sensors for detecting EM wave energy from an environment external to the vehicle, the method further comprising:
detecting, through the one or more electromagnetic (EM) wave sensors, EM wave energy from a surface that the electric drivetrain system of the vehicle interacts with;
receiving, through one or more drive system sensors, real-time drive system operating state data about an electric drive system of the vehicle; and
computing road state data about the surface based on one or more of the real-time positional state data, the real-time drive system operating state data, and detected EM wave energy,
wherein the control signals are computed also based on the road state data.

6. The method of claim 5 wherein the surface interface data includes road state data that includes a prediction of upcoming changes in a surface terrain for each of a plurality of contact locations between the electric drive system and the surface.

7. The method of claim 5 wherein the surface interface data includes an estimation of a grip available between a plurality of wheels of the vehicle and the surface.

8. The method of claim 5 wherein the surface interface data includes an estimation of one or more properties of water, ice or snow located on the surface.

9. The method of claim 1 comprising, prior to applying the control signals to the electric drivetrain system, predicting if execution of the control signals will result in an unsafe vehicle state, and aborting applying the control signals when an unsafe vehicle state is predicted.

10. The method of claim 1 comprising using a machine learning (ML) model to compute the control signals.

11. A vehicle control system for assisting a human driver to control operation of a vehicle, the vehicle control system comprising one or more processors and one or more memories storing software instructions that, when executed by the one or more processors, configure the vehicle control system to perform a method comprising:
receiving, through one or more human-vehicle control interfaces, real time driver controls input data indicating a throttle input signal and a steering angle input signal;
receiving, through one or more vehicle embedded sensor systems, real-time positional state data about the vehicle;
computing, based on the throttle input signal, steering angle input signal, and real-time positional state data a driver's expected vehicle performance;
computing, based on the real-time positional state data, an actual vehicle performance;
computing, based on the driver's expected vehicle performance and a difference between the driver's expected vehicle performance and the actual vehicle performance, control signals for an electric drivetrain system of the vehicle;
applying the control signals to the electric drivetrain system to control real-time operation of the vehicle.

12. The vehicle control system of claim 11 wherein the control signals include wheel torque control signals and steering angle control signals.

13. The vehicle control system of claim 12 wherein the vehicle includes a suspension control system and the control signals include suspension system control signals for controlling operation of the suspension control system in real time.

14. The vehicle control system of claim 12 wherein:
the actual vehicle performance computed based on the real-time positional state data is based on data acquired by an inertial momentum unit of the embedded sensor systems and comprises: values indicating a current vehicle pitch, yaw and roll; values indicating a current vehicle velocity in three orthogonal axis; and values indicating a current vehicle acceleration in three orthogonal axis; and
the driver's expected vehicle performance comprises: values indicating an expected vehicle pitch, yaw and roll; values indicating an expected vehicle velocity in three orthogonal axis; and values indicating an expected vehicle acceleration in three orthogonal axis.

15. The vehicle control system of claim 12 wherein the one or more vehicle embedded sensor systems includes one or more electromagnetic (EM) wave sensors for detecting EM wave energy from an environment external to the vehicle, the method performed by the vehicle control system further comprising:
detecting, through the one or more electromagnetic (EM) wave sensors, EM wave energy from a surface that the electric drivetrain system of the vehicle interacts with;
receiving, through one or more drive system sensors, real-time drive system operating state data about an electric drive system of the vehicle; and
computing road state data about the surface based on one or more of the real-time positional state data, the real-time drive system operating state data, and detected EM wave energy,
wherein the control signals are computed also based on the road state data.

16. The vehicle control system of claim 15 wherein the surface interface data includes road state data that includes a prediction of upcoming changes in a surface terrain for each of a plurality of contact locations between the electric drive system and the surface.

17. The vehicle control system of claim 15 wherein the surface interface data includes an estimation of a grip available between a plurality of wheels of the vehicle and the surface, and the surface interface data includes an estimation of one or more properties of water, snow or ice located on the surface.

18. The vehicle control system of claim 11 wherein the method performed by the vehicle control system comprises, prior to applying the control signals to the electric drivetrain system, predicting if execution of the control signals will result in an unsafe vehicle state, and aborting applying the control signals when an unsafe vehicle state is predicted.

19. The vehicle control system of claim 11 comprising a predictive conditioner that includes a machine learning (ML) model that is trained to compute the control signals by mapping input signals that include the driver's expected vehicle performance and the difference between the driver's expected vehicle performance and the actual vehicle performance to the control signals.

20. A vehicle comprising:
an electric drivetrain system for propelling and steering the vehicle along a surface;
a human-vehicle control interface that includes a throttle control input and a steering control input for receiving real time driver controls input data indicating a throttle input signal and a steering angle input signal, respectively;
a plurality of vehicle embedded sensor systems for sensing real-time positional state data about the vehicle; and
a vehicle control system for assisting a human driver to control operation of the vehicle, the vehicle control system comprising one or more processors and one or more memories storing software instructions that, when executed by the one or more processors, configure the vehicle control system to perform a method comprising:
receiving real-time throttle input signals and steering angle input signals from the human-vehicle control interfaces;
receiving real-time positional state data about the vehicle from the vehicle embedded sensor systems, real-time positional state data about the vehicle;
computing, based on the throttle input signal, steering angle input signal, and real-time positional state data a driver's expected vehicle performance;
computing, based on the real-time positional state data, an actual vehicle performance;
computing, based on the driver's expected vehicle performance and a difference between the driver's expected vehicle performance and the actual vehicle performance, control signals for an electric drivetrain system of the vehicle;
applying the control signals to the electric drivetrain system to control real-time operation of the vehicle.
